(19) United States
(12) Patent Application Publication
(10) Pub. No.: US 2025/0322369 A1
(43) Pub. Date: Oct. 16, 2025

(54) ONLINE MEETING PROCESSING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Yi ZHU, Shenzhen (CN)

(73) Assignee: TENCENT TECHNOLOGY (SHENZHEN) COMPANY LIMITED, Shenzhen (CN)

(21) Appl. No.: 19/249,185

(22) Filed: Jun. 25, 2025

Related U.S. Application Data
(63) Continuation of application No. PCT/CN2024/087215, filed on Apr. 11, 2024.

(30) Foreign Application Priority Data
Jun. 6, 2023 (CN) 202310667755.6

(51) Int. Cl. G06Q 10/1093; G10L 17/02; G10L 17/04; G10L 17/06; G10L 17/22; H04L 12/18; H04L 65/1093; H04L 65/403

(52) U.S. Cl. CPC G06Q 10/1093; G10L 17/02; G10L 17/04; G10L 17/06; G10L 17/22; H04L 12/1818; H04L 65/1093; H04L 65/403

(57) ABSTRACT

An online meeting processing method including displaying a meeting interface of an online meeting logged in through one target account, the target account being provided for a plurality of meeting objects in one meeting place to attend the online meeting, and displaying speaking indication information indicating that a target meeting object is speaking on the meeting interface when any target meeting object in the plurality of meeting objects speaks.

### CROSS-REFERENCE TO RELATED APPLICATIONS

This application is a continuation application of International Application No. PCT/CN2024/087215 filed on Apr. 11, 2024, which claims priority to Chinese Patent Application No. 202310667755.6, filed with the China National Intellectual Property Administration on Jun. 6, 2023, the disclosures of each being incorporated by reference herein in their entireties.

### FIELD

The disclosure relates to the field of Internet technologies, and in particular, to an online meeting processing method and apparatus, an electronic device, a computer-readable storage medium, and a computer program product.

### BACKGROUND

With development of the Internet, online meetings are more widely applied. An online meeting, also known as a web conference or remote collaborative office work, enables a plurality of users in different places to share data over the Internet, and effectively improves efficiency of online collaborative cooperation between clients, partners, and colleagues in various regions.

In the related art, a meeting scene in which a plurality of objects in a same meeting room attend an online meeting is implemented as follows: the online meeting is logged in through one meeting account on a meeting device, and all attendees in the meeting room speak through a microphone associated with the meeting account. However, because only one meeting account (the meeting account for logging in to the online meeting on the meeting device) can be recognized, speeches of all attendees in the meeting room are identified as speeches associated with the meeting account. As a result, another attendee (such as an attendee not in the same meeting room) in the online meeting cannot determine who a current speaker is, which greatly reduces efficiency of the online meeting.

### SUMMARY

Some embodiments provide an online meeting processing method, which is performed by an electronic device and includes: displaying a meeting interface of an online meeting logged in through a target account, the target account being provided for a plurality of meeting objects in a meeting place to attend the online meeting; and displaying, on the meeting interface, speaking indication information indicating that a target meeting object is speaking when any target meeting object in the plurality of meeting objects speaks.

Some embodiments provide an online meeting processing apparatus, which includes: at least one memory configured to store computer program code; and at least one processor configured to read the program code and operate as instructed by the program code, the program code comprising: first display code configured to cause at least one of the at least one processor to display a meeting interface of an online meeting logged in through one target account, the target account being provided for a plurality of meeting objects in one meeting place to attend the online meeting; and second display code configured to cause at least one of the at least one processor to display, on the meeting interface, speaking indication information indicating that a target meeting object is speaking when any target meeting object in the plurality of meeting objects speaks.

Some embodiments provide a non-transitory computer-readable storage medium, storing computer code which, when executed by at least one processor, causes the at least one processor to at least: display a meeting interface of an online meeting logged in through a target account, the target account being provided for a plurality of meeting objects in a meeting place to attend the online meeting; and display, on the meeting interface, speaking indication information indicating that a target meeting object is speaking when any target meeting object in the plurality of meeting objects speaks.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic architectural diagram of an online meeting processing system 100 according to some embodiments.

FIG. 2 is a schematic structural diagram of an electronic device configured to implement an online meeting processing method according to some embodiments.

FIG. 3 is a schematic flowchart of an online meeting processing method according to some embodiments.

FIG. 4 is a schematic diagram of display of a meeting scheduling interface according to some embodiments.

FIG. 5 is a schematic diagram of display of a voiceprint registration interface according to some embodiments.

FIG. 6 is a schematic diagram of display of meeting joining information according to some embodiments.

FIG. 7 is a schematic flowchart of virtual login according to some embodiments.

FIG. 8 is a flowchart of removal of a virtual login account according to some embodiments.

FIG. 9 is a schematic diagram of display of speaking indication information according to some embodiments.

FIG. 10 is a schematic diagram of display of speaking indication information according to some embodiments.

FIG. 11 is a schematic diagram of display of meeting minutes according to some embodiments.

FIG. 12 is a schematic diagram of registration with an online meeting client according to some embodiments.

FIG. 13 is a schematic flowchart of an online meeting processing method according to some embodiments.

FIG. 14 is a schematic flowchart of processing of a virtual attendee management module according to some embodiments.

FIG. 15 is a schematic diagram of a binding relationship between a meeting management object and a virtual attendee according to some embodiments.

FIG. 16 is a schematic flowchart of processing of a voice recognition module according to some embodiments.

FIG. 17 is a schematic diagram of storage of a voiceprint feature according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

The terms, involved in the following description, “first/second/third” are merely intended to distinguish similar objects rather than describing specific orders of the objects. “First/second/third” is interchangeable in proper circumstances to enable various embodiments to be implemented in other orders than those illustrated or described herein.

Unless otherwise defined, meanings of all technical and scientific terms used herein are the same as those usually understood by those skilled in the art to which this application belongs. The terms used herein are merely intended to describe objectives of some embodiments, but are not intended to be limiting.

Before various embodiments are described in further detail, a description is made on nouns and terms used herein, and the nouns and terms are applicable to the following explanations.
1) Client: it is an application (APP) that provides various services and that runs on a terminal, such as a client supporting an online meeting.
2) In response to: it is configured for representing a condition or status on which a to-be-performed operation depends. When the condition or status is satisfied, one or more operations may be performed in real time or after a set delay. Without being specifically stated, the order in which the operations are performed is not limited.
3) Online meeting: it is also known as a web conference or remote collaborative office work, enables a plurality of users in different places (meeting places) to share data over the Internet, and effectively improves efficiency of online collaborative cooperation between clients, partners, and colleagues in various regions.
4) Voiceprint: it is an acoustic spectrum that is displayed by an electroacoustic instrument and that carries verbal information.
5) Speaker recognition: it is also known as voiceprint recognition, and is a biometric recognition technology in which a speaker is distinguished based on a voice, to perform identity verification and authentication.

Some embodiments provide an online meeting processing method and apparatus, an electronic device, a computer-readable storage medium, and a computer program product, to improve meeting efficiency and meeting experience of an online meeting. According to some embodiments, when the online meeting is logged in through one target account, and the target account is provided for the plurality of meeting objects in one meeting place to attend the online meeting, the speaking indication information configured for indicating that the target meeting object is speaking may be displayed on the meeting interface when any target meeting object in the plurality of meeting objects speaks. In this way, for a meeting scene in which a plurality of objects in a same meeting place attend an online meeting through one meeting account, different speaking indication information can be displayed when different meeting objects speak, to clearly identify, based on the speaking indication information, which meeting object in the plurality of meeting objects is speaking. Therefore, meeting efficiency and meeting experience of the online meeting are improved. Respective descriptions are provided below.

Here, the data collection and processing in this application needs to strictly conform to the requirements of relevant laws and regulations during application of the embodiments, and the informed consent or separate consent needs to be acquired from a personal information subject. Subsequent data use and processing need to be carried out within the scope of authorization of laws and regulations and the personal information subject.

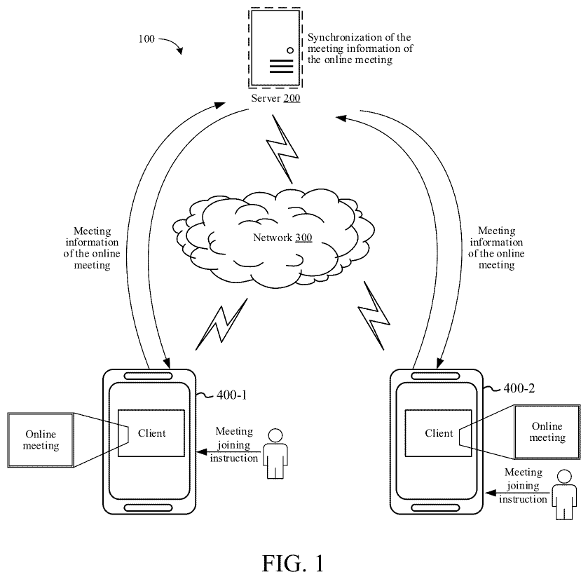

FIG. 1 is a schematic architectural diagram of an online meeting processing system 100 according to some embodiments. To support an exemplary application, a terminal 400-1 and a terminal 400-2 are connected to a server 200 through a network 300. The network 300 may be a wide area network, a local area network, or a combination of the wide area network and the local area network, and uses a wireless or wired link for data transmission. The terminal 400-1 corresponds to a first meeting place and logs in to an online meeting through a first target account, the terminal 400-2 corresponds to a second meeting place and logs in to the online meeting through a second target account, and both the first meeting place and the second meeting place include a plurality of meeting objects. The terminal 400-1 and the terminal 400-2 synchronize meeting information of the online meeting (for example, speaking content in the online meeting) through the server 200.

A description is made by using an example in which the terminal is the terminal 400-1. The terminal 400-1 is configured to in response to a meeting joining instruction for logging in to an online meeting through a target account (namely, the first target account), transmit, to the server 200, a meeting joining request for logging in to the online meeting through the target account. The server 200 is configured to receive the meeting joining request transmitted by the terminal; and control, in response to the meeting joining request, the terminal to log in to the online meeting through the target account. The terminal 400-1 is further configured to display, when the server 200 controls the terminal to log in to the online meeting through the target account, a meeting interface of the online meeting logged in through the target account, the target account being provided for a plurality of meeting objects in one meeting place to attend the online meeting; and display, on the meeting interface when any target meeting object in the plurality of meeting objects speaks, speaking indication information configured for indicating that the target meeting object is speaking. Meanwhile, the speaking indication information may further be synchronized to another terminal (namely, the terminal 400-2) attending the online meeting, and the terminal 400-2 also displays, on the meeting interface, the speaking indication information configured for indicating that the target meeting object is speaking. In this way, for a meeting scene in which a plurality of objects in a same meeting place attend an online meeting through one meeting account, different speaking indication information can be displayed when different meeting objects speak, to clearly identify, based on the speaking indication information, which meeting object in the plurality of meeting objects is speaking. Therefore, meeting efficiency and meeting experience of the online meeting are improved.

In some embodiments, an online meeting processing method may be implemented by various electronic devices, for example, may be implemented by a terminal alone, or may be implemented by a server alone, or may be implemented cooperatively by a terminal and a server. The online meeting processing method provided in some embodiments may be applied to various scenarios, including but not limited to cloud technology, artificial intelligence, intelligent transportation, assisted driving, a game, audio or video, online meeting, instant messaging, and the like.

In some embodiments, an electronic device configured to implement the online meeting processing method may be various types of terminals or servers. The server (such as the server 200) may be an independent physical server, a server cluster or distributed system including a plurality of physical servers. The terminal (such as the terminal 400-1) may be, but is not limited to, a laptop, a tablet computer, a desktop computer, a smartphone, a smart voice interaction device (such as a smart speaker), a smart home appliance (such as a smart television), a smart watch, an on-board terminal, a wearable device, and a virtual reality (VR) device. The terminal and the server may be directly or indirectly connected through wired or wireless communication. This is not limited herein.

In some embodiments, the online meeting processing method may be implemented by cloud technology. The cloud technology is a hosting technology that unifies a series of resources such as hardware, software, and networks in a wide area network or a local area network, to implement computing, storage, processing, and sharing of data. The cloud technology is a generic term of a network technology, an information technology, an integration technology, a management platform technology, and an application technology based on application of a cloud computing business model. The resources may form a resource pool and are used on demand, which is flexible and convenient. The cloud computing technology will become an important support. Backend services of a technological network system require a lot of computing and storage resources. As an example, the server (such as the server 200) may be a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform.

In some embodiments, a plurality of servers may form a blockchain. The server is a node on the blockchain. Each node of the blockchain may have information connection, and information transmission may be performed between nodes through the information connection. Data (such as meeting minutes and voice data of a meeting object) related to the online meeting processing method may be stored in a blockchain.

In some embodiments, the terminal or the server may implement the online meeting processing method by running various computer-executable instructions or a computer program. For example, the computer-executable instructions may be a microprogram-level command, machine instructions, or software instructions. For example, the computer program may be an original program or a software module in an operating system; or may be a native APP, namely, a program that needs to be installed in the operating system for running, such as a meeting APP; or may be a mini program that can be embedded into any APP, namely, a program that only needs to be downloaded into a browser environment for running. In a word, the foregoing computer-executable instructions may be instructions in any form, and the foregoing computer program may be an APP, module, or plug-in in any form.

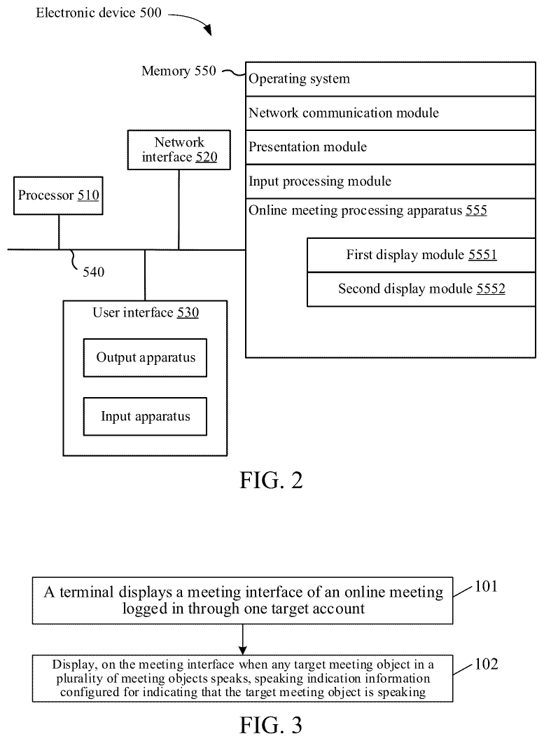

FIG. 2 is a schematic structural diagram of an electronic device 500 configured to implement an online meeting processing method according to some embodiments. The electronic device 500 may be a terminal or a server. The electronic device 500 includes: at least one processor 510, a memory 550, at least one network interface 520, and a user interface 530. The components in the electronic device 500 are coupled together through a bus system 540. The bus system 540 is configured to implement connection and communication between the components. In addition to a data bus, the bus system 540 further includes a power bus, a control bus, and a state signal bus. However, for clarity of description, all types of buses in FIG. 2 are marked as the bus system 540.

In some embodiments, an online meeting processing apparatus may be implemented in the form of software. FIG. 2 shows an online meeting processing apparatus 555 stored in the memory 550, which may be software in the form of programs, plug-ins, or the like, and include the following software modules: a first display module 5551 and a second display module 5552. Because these modules are logical, they may be combined in different manners or further split according to implemented functions. The functions of each module are described below.

In some embodiments, the online meeting processing method may be implemented by various electronic devices, for example, may be implemented by a terminal alone, or may be implemented by a server alone, or may be implemented cooperatively by a terminal and a server. A description is made by using an example in which the online meeting processing method is implemented by a terminal. FIG. 3 is a schematic flowchart of an online meeting processing method according to some embodiments.

Operation 101: A terminal displays a meeting interface of an online meeting logged in through one target account.

The target account is provided for a plurality of meeting objects in one meeting place to attend the online meeting.

Herein, the terminal may be provided with a client supporting an online meeting, and a user may attend the online meeting by running the client on the terminal. In some embodiments, the terminal may log in to the online meeting through the target account. In this way, the terminal displays the meeting interface of the online meeting logged in through the target account. The target account may be a login account of the client, and the terminal may log in to the online meeting through the target account when the client is in a logged-in state with the target account. In addition, a meeting object in each of a plurality of meeting places joins the online meeting through the target account corresponding to each meeting place, to implement a meeting among the meeting objects in the plurality of meeting places.

In addition, the target account may belong to a meeting management object of the online meeting. The meeting management object can schedule the online meeting, manage the meeting object in the online meeting, manage related information (such as a start and an end of the online meeting, meeting duration of the online meeting, and a meeting location) of the online meeting, and the like. The plurality of meeting objects includes the meeting management object, and a meeting object other than the meeting management object in the plurality of meeting objects may be referred to as a meeting attendance object. During actual implementation, one meeting management object may exist in each meeting place corresponding to the online meeting. In some embodiments, one meeting management object may exist in one online meeting. In some embodiments, the target account is provided for the plurality of meeting objects in one meeting place to attend the online meeting. In this way, a meeting scene in which the plurality of meeting objects in the same meeting place attend the online meeting through one meeting account (namely, the target account) is formed.

In addition, for a meeting scene in which a plurality of objects in a same meeting place attend an online meeting through one meeting account, it is expected in some embodiments that different speaking indication information can be displayed when different meeting objects speak, to clearly identify, based on the speaking indication information, which meeting object in the plurality of meeting objects is speaking. Therefore, each terminal attending the online meeting may display, on the meeting interface when any target meeting object in the plurality of meeting objects speaks, the speaking indication information configured for indicating that the target meeting object is speaking. Next, a description is made by using an example in which the terminal is a terminal of the meeting management object.

In some embodiments, before displaying the meeting interface of the online meeting logged in through one target account, the terminal may schedule the online meeting in the following manner: displaying a meeting scheduling interface; receiving meeting setting information for the online meeting based on the meeting scheduling interface; and scheduling the online meeting in response to a confirmation operation for the meeting setting information.

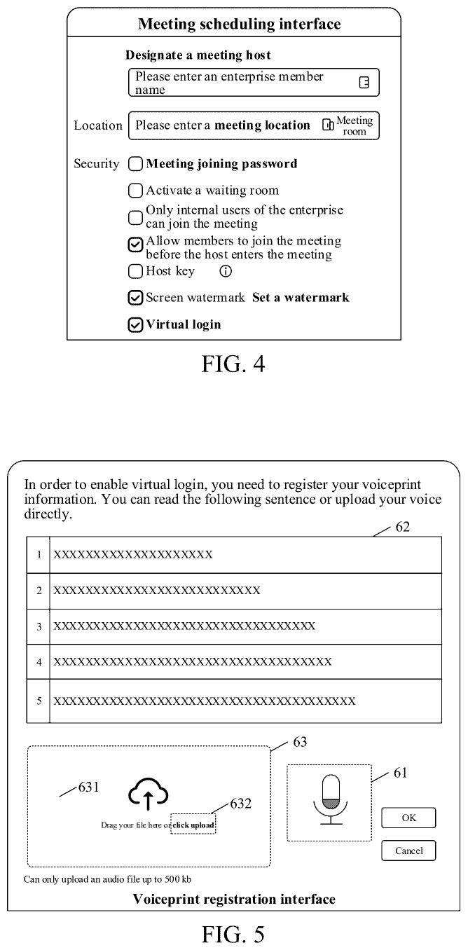

Herein, a user (such as the meeting management object) may schedule the online meeting. Specifically, the terminal displays the meeting scheduling interface in response to an online meeting scheduling instruction triggered by the user (for example, the online meeting scheduling instruction is triggered through an online meeting scheduling control). FIG. 4 is a schematic diagram of display of a meeting scheduling interface according to some embodiments. Herein, the meeting scheduling interface may be provided for the user to set meeting setting information of the online meeting, such as a meeting location of the online meeting, a name of the meeting management object (namely, a meeting host) attending the online meeting, an entrance password for joining the online meeting, and whether to enable a virtual login mode. After receiving the meeting setting information that is set by the user based on the meeting scheduling interface, the terminal schedules, according to the meeting setting information, the online meeting in response to a confirmation operation for the meeting setting information. In this way, scheduling of the online meeting is achieved. The meeting object may attend the online meeting by joining the scheduled online meeting.

In some embodiments, the target account belongs to the meeting management object in the plurality of meeting objects, and before displaying the meeting interface of the online meeting logged in through one target account, the terminal may register an object voiceprint of the meeting management object with an object voiceprint library of the online meeting in the following manner: displaying a voiceprint registration interface of the online meeting in response to a first entry instruction of the meeting management object for the online meeting; receiving an object voice of the meeting management object based on the voiceprint registration interface; and adding a voiceprint of the object voice as the object voiceprint of the meeting management object to the object voiceprint library in response to a confirmation operation for the object voice.

In addition, for a meeting scene in which a plurality of objects in a same meeting place attend an online meeting through one meeting account, it is expected in some embodiments that different speaking indication information can be displayed when different meeting objects speak, to clearly identify, based on the speaking indication information, which meeting object in the plurality of meeting objects is speaking. Therefore, when entering (or logging in to) the online meeting for the first time, a user needs to register a voiceprint of the user with an object voiceprint library of the online meeting. Based on this, herein, when receiving the first entry instruction of the meeting management object for the online meeting, the terminal displays the voiceprint registration interface of the online meeting. The user may enter a voice of the user through the voiceprint registration interface, to register a voiceprint of the user with the object voiceprint library of the online meeting. When receiving the object voice of the meeting management object based on the voiceprint registration interface, the terminal performs voiceprint recognition on the object voice in response to the confirmation operation for the object voice, to obtain the voiceprint of the object voice, and adds the voiceprint of the object voice as the object voiceprint of the meeting management object to the object voiceprint library, whereby registration of the object voiceprint of the meeting management object with the object voiceprint library of the online meeting is achieved. In this way, after scheduling the online meeting, the meeting management object is guided to register the object voiceprint of the meeting management object with the object voiceprint library when entering the online meeting for the first time, which facilitates operations of the meeting management object, and improves efficiency of voiceprint registration of the meeting management object.

In some embodiments, the terminal may display a voice collection control and voice collection reference text on the voiceprint registration interface; and correspondingly, the terminal may receive the object voice of the meeting management object based on the voiceprint registration interface in the following manner: receiving, based on the voice collection control, an object voice of the meeting management object reading the voice collection reference text.

Herein, the voice collection control and the voice collection reference text may be provided on the voiceprint registration interface. The voice collection control is configured to collect a voice in response to a trigger operation for the voice collection control. The voice collection reference text is provided for a user to reference when performing voice input. Based on this, the terminal may receive, based on the voice collection control, the object voice of the meeting management object reading the voice collection reference text. In this way, voice collection can be achieved according to the voice collection reference text. The voiceprint registration operation is simplified for the user, and the terminal acquires a more accurate voiceprint, whereby accuracy of subsequent determination of a speaking object through voiceprint recognition is improved.

In some embodiment, the terminal may display a voice file uploading control on the voiceprint registration interface; and correspondingly, the terminal may receive the object voice of the meeting management object based on the voiceprint registration interface in the following manner: receiving, based on the voice file uploading control, an uploaded voice file of the meeting management object; and taking a voice included in the voice file as the object voice in response to a confirmation operation for the voice file.

Herein, the voice file uploading control may further be provided on the voiceprint registration interface. The voice file uploading control is provided for a user to upload a voice file including a voice of the user through the voice file uploading control. Based on this, the terminal may receive the uploaded voice file of the meeting management object through the voice file uploading control. The voice included in the voice file is the object voice of the meeting management object. In some embodiments, the voice file uploading control includes a file dragging uploading functional area and a file selection uploading control. The user may upload the voice file by dragging the voice file to the file dragging uploading functional area, or the user may select the voice file from a file directory for uploading through the file selection uploading control. Herein, the manner of uploading the voice file to implement voiceprint registration is further provided, and implementations of voiceprint registration are increased, whereby voiceprint registration can adapt to more scenarios, and convenience of voiceprint registration of a user is increased.

FIG. 5 is a schematic diagram of display of a voiceprint registration interface according to some embodiments. Herein, a terminal displays a voiceprint registration interface, and displays a voice collection control 61, voice collection reference text 62, and a voice file uploading control 63 on the voiceprint registration interface. Herein, the voice file uploading control 63 includes a file dragging uploading functional area 631 and a file selection uploading control 632.

In some embodiments, the target account belongs to the meeting management object in the plurality of meeting objects, and the terminal may display a meeting object addition control of the online meeting; and display meeting joining information in response to a trigger operation of the meeting management object for the meeting object addition control. The meeting joining information is configured for joining the online meeting in a virtual login mode in response to a joining instruction that is triggered by a meeting attendance object based on the meeting joining information and that is for the online meeting, and the meeting attendance object is a meeting object other than the meeting management object in the plurality of meeting objects. The virtual login mode is configured for instructing to bind a virtual login account to the target account when the virtual login account of the meeting attendance object is received, and registering an object voiceprint of the meeting attendance object with the object voiceprint library, whereby the meeting attendance object joins the online meeting based on the virtual login account.

Herein, after entering the online meeting, the meeting management object may further add the meeting attendance object of the online meeting. In some embodiments, the added meeting object joins the online meeting in the virtual login mode. Specifically, the terminal of the meeting management object may display the meeting object addition control of the online meeting. For example, the terminal displays the meeting object addition control on an object management interface of the online meeting. The terminal displays the meeting joining information when receiving the trigger operation for the meeting object addition control.

In some embodiments, the meeting joining information may be a meeting joining graphic code (such as a quick-response code), a meeting joining link, a meeting joining password, or the like. In this way, after displaying the meeting joining information, the terminal may transmit the meeting joining information to a target terminal of the meeting attendance object, whereby the meeting attendance object may join the online meeting based on the meeting joining information displayed by the target terminal. In some embodiments, after displaying the meeting joining information, the terminal may not transmit the meeting joining information to the target terminal of the meeting attendance object. Instead, the meeting attendance object performs an operation on the terminal, to join the online meeting based on the meeting joining information displayed by the terminal. In this case, if a plurality of meeting attendance objects exist, corresponding meeting joining information may be provided for each meeting attendance object by triggering the meeting object addition control. In some embodiments, one piece of meeting joining information may be provided for the plurality of meeting attendance objects by triggering the meeting object addition control only once. When performing an operation based on the meeting joining information, each meeting attendance object may identify an identity of the meeting attendance object, for example, enter a name of the meeting attendance object. Exemplarily, when the meeting joining information is a meeting joining graphic code, if the terminal does not transmit the meeting joining graphic code to the target terminal of the meeting attendance object, no matter whether one or more meeting attendance objects exist, the terminal may trigger the trigger operation for the meeting object addition control only once, to display one meeting joining graphic code, and the plurality of meeting attendance objects may join the online meeting through the meeting joining graphic code. Each meeting attendance object may join the online meeting by scanning the graphic code. To identify a personal identity of the meeting attendance object, after scanning the graphic code, the meeting attendance object may enter an identifier, such as a personal name, and then join the online meeting.

In some embodiments, when joining the online meeting based on the meeting joining information, the meeting attendance object joins the online meeting in the virtual login mode. The virtual login mode is configured for instructing to bind a virtual login account to the target account when the virtual login account of the meeting attendance object is received, and registering an object voiceprint of the meeting attendance object with the object voiceprint library, whereby the meeting attendance object joins the online meeting based on the virtual login account. Specifically, the target terminal of the meeting attendance object displays a virtual login interface of the online meeting in response to a joining instruction that is triggered by the meeting attendance object based on the meeting joining information and that is for the online meeting; receives the virtual login account for the online meeting based on the virtual login interface; binds, in response to a confirmation operation for the virtual login account, the virtual login account to the target account for logging in to the online meeting, and displays the voiceprint registration interface of the online meeting; receives an object voice of the meeting attendance object based on the voiceprint registration interface; and adds a voiceprint of the object voice as an object voiceprint of the meeting attendance object to the object voiceprint library of the online meeting in response to a confirmation operation for the object voice, whereby the meeting attendance object joins the online meeting based on the virtual login account. In this way, virtual login of the meeting attendance object is completed.

In some embodiments, the joining instruction may be received in the following manner: when the meeting joining information is a meeting joining graphic code, the joining instruction is received in response to a scanning operation for the meeting joining graphic code; when the meeting joining information is a meeting joining link, the joining instruction is received in response to an access operation for the meeting joining link; or when the meeting joining information is a meeting joining password, the joining instruction is received in response to a recognition operation for the meeting joining password. Exemplarily, the graphic code may be a quick-response code, a bar code, or the like. The meeting attendance object may scan the graphic code by using a personal terminal to trigger the joining instruction. The meeting joining link may be transmitted by the terminal of the meeting management object to the personal terminal of the meeting attendance object. When receiving an access operation (such as a click operation) for the meeting joining link, the personal terminal of the meeting attendance object receives the joining instruction. The meeting joining password may be transmitted by the terminal of the meeting management object to the personal terminal of the meeting attendance object. When the personal terminal of the meeting attendance object receives a copying operation for the meeting joining password and in a case that the meeting joining password has been copied, a client supporting an online meeting is activated. The client may automatically perform a recognition operation for the meeting joining password, and receive the joining instruction in response to the recognition operation for the meeting joining password. In this way, the user may join the online meeting in a plurality of manners, and may select an appropriate manner to use as needed, whereby applicable scenarios of the online meeting joining manner are enriched.

In some embodiments, the virtual login interface may be provided for the user to enter the virtual login account. Exemplarily, the virtual login account may be a mobile phone number registered with a client (namely, a client supporting an online meeting), and virtual login is achieved through mobile phone number verification (namely, a mobile phone verification code). When the mobile phone number is not registered with the client, registration may be first performed, and then virtual login is performed. Exemplarily, the virtual login account may be a client account generated by registering with the client, and virtual login is achieved by inputting the client account and a corresponding account password. The voiceprint registration interface is provided for the meeting attendance object to upload the object voice of the meeting attendance object, and register the object voiceprint of the meeting attendance object with the object voiceprint library of the online meeting. For the voiceprint registration interface, refer to FIG. 5. Exemplarily, the personal terminal of the meeting attendance object may display the voice collection control and the voice collection reference text on the voiceprint registration interface, and receive, based on the voice collection control, the object voice of the meeting attendance object reading the voice collection reference text. Exemplarily, the personal terminal of the meeting attendance object may display the voice file uploading control on the voiceprint registration interface, receive, based on the voice file uploading control, the uploaded voice file of the meeting attendance object, and take the voice included in the voice file as the object voice of the meeting attendance object in response to the confirmation operation for the voice file.

After the object voice of the meeting attendance object is received, the voiceprint of the object voice is added as the object voiceprint of the meeting attendance object to the object voiceprint library of the online meeting in response to the confirmation operation for the object voice. In this way, the meeting attendance object may join the online meeting based on the virtual login account, and when the meeting attendance object speaks at the online meeting, a meeting attendance object who is speaking can be determined according to the object voiceprint of the meeting attendance object.

In some embodiments, the virtual login account for joining the online meeting may be understood as a virtual attendee, and the virtual attendee corresponds to the meeting attendance object corresponding to the virtual login account.

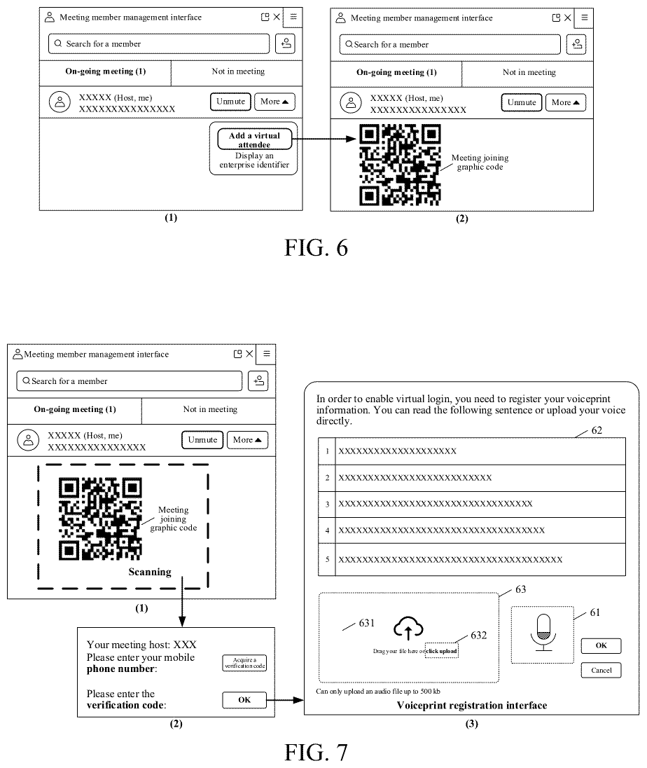

FIG. 6 is a schematic diagram of display of meeting joining information according to some embodiments. Herein, the terminal (of the meeting management object) displays, on a meeting member management interface, a meeting object addition control “Add a virtual attendee” of an online meeting, as shown in FIG. 6(1); and displays meeting joining information in response to a trigger operation for the meeting object addition control “Add a virtual attendee”. The meeting joining information is a meeting joining graphic code (a quick-response code), as shown in FIG. 6(2).

FIG. 7 is a schematic flowchart of virtual login according to some embodiments. Herein, the meeting attendance object may scan the displayed meeting joining graphic code by using the held target terminal. The target terminal receives the joining instruction for the online meeting in response to a scanning operation for the meeting joining graphic code. In this case, a virtual login interface is displayed, as shown in FIG. 7(1) and FIG. 7(2). The virtual login interface may be provided for the meeting attendance object to enter the virtual login account (namely, the mobile phone number), and a corresponding mobile phone verification code. In response to a confirmation operation for the virtual login account that is triggered based on an “OK” control on the virtual login interface, the virtual login account is bound to the target account for logging in to the online meeting, and the voiceprint registration interface of the online meeting is displayed, as shown in FIG. 7(3). Based on the voiceprint registration interface, the object voice of the meeting attendance object may be received. In response to the confirmation operation that is triggered based on the “OK” control on the voiceprint registration interface and that is for the object voice, the voiceprint of the object voice is added as the object voiceprint of the meeting attendance object to the object voiceprint library of the online meeting, whereby the meeting attendance object joins the online meeting based on the virtual login account. In this way, virtual login of the meeting attendance object is completed.

In some embodiments, the terminal may enable the virtual login mode in the following manner: displaying a virtual login switch of the online meeting; and controlling the online meeting to be in the virtual login mode in response to an enabling instruction for the virtual login switch; and correspondingly, the terminal may display the meeting object addition control of the online meeting when the online meeting is in the virtual login mode. Refer to FIG. 4. As an example, a virtual login switch “Virtual login” may be displayed on the meeting scheduling interface. When the online meeting is scheduled, the virtual login switch may be enabled, and the online meeting is in the virtual login mode. In some embodiments, the virtual login switch may be displayed on the meeting interface or a meeting management interface of the online meeting after the terminal enters the online meeting. This is not limited herein. In this way, when controlling the online meeting to be in the virtual login mode, the terminal may display the meeting object addition control of the online meeting, and add the meeting attendance object in the virtual login mode, whereby the meeting attendance object joins the online meeting in the virtual login mode.

In some embodiments, the meeting attendance object joins the online meeting in the virtual login mode, and the terminal may remove the virtual login account of the meeting attendance object in the following manner: displaying an account removal control of the virtual login account; and controlling, in response to a trigger operation for the account removal control, the virtual login account to exit the online meeting.

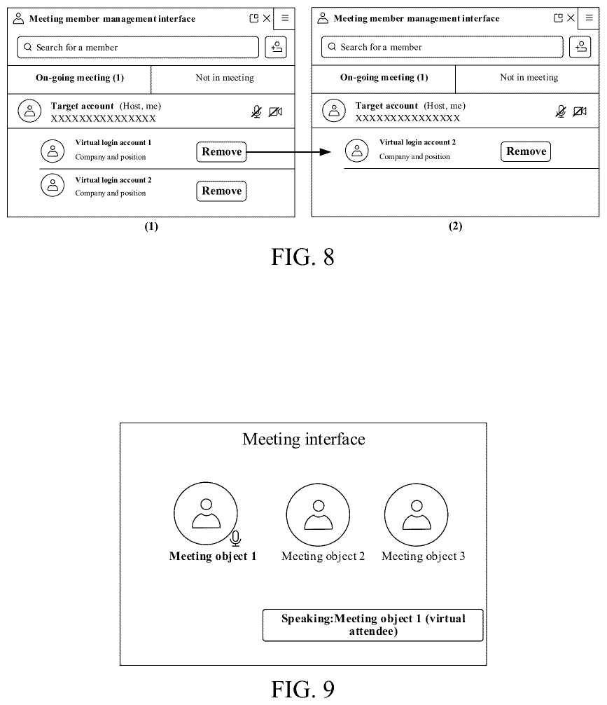

Herein, the meeting attendance object (referring to a meeting object other than the meeting management object in the plurality of meeting objects) of the online meeting may join the online meeting in the virtual login mode. In this way, the target account is bound with the virtual login account of each meeting attendance object. In some embodiments, the meeting management object may remove the virtual login account bound to the target account. FIG. 8 is a flowchart of removal of a virtual login account according to some embodiments. Herein, the terminal displays account information of the target account, displays account information of virtual login accounts 1 and 2 bound to the target account in an associated area of the account information of the target account, and displays an account removal control “Remove” of each virtual login account, as shown in FIG. 8(1); and controls, in response to a trigger operation for the account removal control “Remove” of the virtual login account 1, the virtual login account 1 to exit the online meeting. In this case, the remaining virtual login account 2 is in the online meeting, as shown in FIG. 8(2). In this way, the meeting management object may manage the virtual login account joining the online meeting as needed, which improves management flexibility of the online meeting.

In some embodiments, the meeting attendance object joins the online meeting in the virtual login mode, and the terminal may exit the online meeting in the following manner: controlling, in response to a meeting exit operation for the target account, the target account to exit the online meeting, and controlling the virtual login account bound to the target account to exit the online meeting.

Herein, the meeting attendance object (referring to a meeting object other than the meeting management object in the plurality of meeting objects) of the online meeting may join the online meeting in the virtual login mode. In this way, the target account is bound with the virtual login account of each meeting attendance object. Because the virtual login account joins the online meeting by binding the target account, when the target account exits the online meeting, the virtual login account bound to the target account also automatically exits the online meeting. That is, when receiving the meeting exit operation for the target account, the terminal controls the target account to exit the online meeting, and controls the virtual login account bound to the target account to exit the online meeting.

In some embodiments, the online meeting has the object voiceprint library, and the object voiceprint library includes the object voiceprint of each meeting object in the plurality of meeting objects. The terminal may determine the target meeting object who is speaking in the following manner: performing voice detection on the online meeting, and acquiring a voiceprint of a target voice when detecting the target voice; matching the voiceprint with each object voiceprint, to obtain a matching result; and determining, when the matching result represents that a target object voiceprint matched with the voiceprint exists, a meeting object having the target object voiceprint is speaking, the meeting object having the target object voiceprint being the target meeting object.

Herein, based on the foregoing embodiments, when joining the online meeting, the meeting object registers the object voiceprint of the meeting object with the object voiceprint library of the online meeting. In this way, the object voiceprint library includes the object voiceprint of each meeting object in the plurality of meeting objects joining the online meeting. Based on this, during the online meeting, the terminal may perform voice detection on the online meeting, that is, detect whether someone is speaking, and recognize the voiceprint of the target voice when detecting the target voice; then, perform similarity matching on the voiceprint and each object voiceprint, to obtain the matching result, the matching result being configured for representing whether the target object voiceprint (that is, an object voiceprint whose similarity reaches a similarity threshold) matched with the voiceprint exists; and determine, when the matching result represents that the target object voiceprint matched with the voiceprint exists, that the meeting object having the target object voiceprint is speaking. Herein, the meeting object having the target object voiceprint is the target meeting object. In this case, the speaking indication information configured for indicating that the target meeting object is speaking is displayed. In this way, the target meeting object that is currently speaking is determined through voiceprint matching. Based on this, different speaking indication information may be displayed when different meeting objects are speaking, to clearly identify, based on the speaking indication information, which meeting object in a plurality of meeting objects is speaking. Therefore, meeting efficiency and meeting experience of an online meeting are improved.

In some embodiments, each meeting object in the plurality of meeting objects corresponds to one speaking control key. The terminal may determine the target meeting object who is speaking in the following manner: detecting whether the speaking control key corresponding to each meeting object is in a pressed state, to obtain a detection result; and determining, when the detection result represents that a target speaking control key is in the pressed state, that a meeting object corresponding to the target speaking control key is speaking, the meeting object corresponding to the target speaking control key being the target meeting object.

Herein, one corresponding speaking control key may be allocated to each meeting object, and the speaking control key may be one physical device. When speaking, the meeting object may press the corresponding speaking control key. In this case, the speaking control key is in the pressed state. Based on this, the terminal may detect whether the speaking control key corresponding to each meeting object is in the pressed state, to obtain the detection result; and determine, when the detection result represents that the target speaking control key is in the pressed state, that the meeting object corresponding to the target speaking control key is speaking. Herein, the meeting object corresponding to the target speaking control key is the target meeting object. In this case, the speaking indication information configured for indicating that the target meeting object is speaking is displayed. In this way, the target meeting object who is currently speaking is accurately determined by configuring the speaking control key and detecting whether the speaking control key is in the pressed state. Based on this, different speaking indication information may be displayed when different meeting objects are speaking, to clearly identify, based on the speaking indication information, which meeting object in a plurality of meeting objects is speaking. Therefore, meeting efficiency and meeting experience of an online meeting are improved.

In some embodiments, the terminal device may determine the target meeting object who is speaking in the following manner: performing voice detection on the online meeting, and recognizing a target speaking direction of the target voice when detecting the target voice; acquiring an object speaking direction of each meeting object in the plurality of meeting objects, and matching the target speaking direction with each object speaking direction, to obtain a matching result; and determining, when the matching result represents that a target object speaking direction matched with the target speaking direction exists, that a meeting object corresponding to the target object speaking direction is speaking, the meeting object corresponding to the target object speaking direction being the target meeting object.

Herein, the target meeting object who is speaking may be determined through speaking direction recognition. During the online meeting, the terminal may perform voice detection on the online meeting, that is, detect whether someone is talking, and recognize the target speaking direction of the target voice when detecting the target voice; then, acquire the object speaking direction of each meeting object in the plurality of meeting objects, perform similarity matching on the target speaking direction and each object speaking direction, to obtain a matching result, the matching result being configured for representing whether the target object speaking direction matched with the target speaking direction (that is, an object speaking direction whose similarity reaches a similarity threshold) exists; and determine, when the matching result represents that the target object speaking direction matched with the target speaking direction exists, that the meeting object corresponding to the target object speaking direction is speaking. Herein, the meeting object corresponding to the target object speaking direction is the target meeting object. In this case, the speaking indication information configured for indicating that the target meeting object is speaking is displayed. In this way, the target meeting object who is currently speaking is determined by detecting the speaking direction of the target voice. Based on this, different speaking indication information may be displayed when different meeting objects are speaking, to clearly identify, based on the speaking indication information, which meeting object in a plurality of meeting objects is speaking. Therefore, meeting efficiency and meeting experience of an online meeting are improved.

In some embodiments, before displaying the meeting interface of the online meeting logged in through one target account, the terminal may further add the object voiceprint to the object voiceprint library in the following manner: displaying a voiceprint addition control; displaying the voiceprint registration interface of the online meeting in response to a trigger operation for the voiceprint addition control; receiving an object voice of a meeting object and an object identifier of the meeting object based on the voiceprint registration interface; and taking a voiceprint of the object voice as an object voiceprint of the meeting object in response to a confirmation operation for the object voice, and associatively adding the object voiceprint and the object identifier to the object voiceprint library.

Herein, one voiceprint addition control configured to add an object voiceprint may be provided, and the meeting object attending the online meeting may add the object voiceprint through the voiceprint addition control. In response to the trigger operation for the voiceprint addition control, the voiceprint registration interface of the online meeting is displayed. For the voiceprint registration interface, refer to FIG. 5. A difference is that the voiceprint registration interface may further include one object identifier addition control, and an object identifier of a meeting object who is currently entering an object voice may be added through the object identifier addition control. Based on this, the object voice of the meeting object and the object identifier of the meeting object may be received based on the voiceprint registration interface. When a confirmation operation for the object voice is received, a voiceprint of the object voice is taken as the object voiceprint of the meeting object, and the object voiceprint and the object identifier are associatively added to the object voiceprint library.

Operation 102: Display, on the meeting interface when any target meeting object in the plurality of meeting objects speaks, speaking indication information configured for indicating that the target meeting object is speaking.

Herein, for a meeting scene in which a plurality of objects in a same meeting place attend an online meeting through one meeting account, when any target meeting object in the plurality of meeting objects speaks, speaking indication information configured for indicating that the target meeting object is speaking is displayed on a meeting interface. In this way, different speaking indication information can be displayed when different meeting objects speak, to clearly identify, based on the speaking indication information, which meeting object in the plurality of meeting objects is speaking. FIG. 9 is a schematic diagram of display of speaking indication information according to some embodiments. Herein, speaking indication information “Speaking: meeting object 1 (virtual attendee)” indicating that “Meeting object 1” is speaking is displayed on the meeting interface. In some embodiments, the speaking indication information may be text information (for example, the meeting object 1 is speaking), image information (a static image or a dynamic image, for example, a dynamic image of “Microphone” is displayed in an associated area of identifier information of the meeting object 1, to indicate that the meeting object 1 is speaking), or the like.

In some embodiments, the terminal may further transmit, to a target terminal logged in through a first account, a notification message indicating that the target meeting object is speaking. The first account is provided for a meeting object in a target meeting place different from the meeting place to attend the online meeting. The notification message is configured for notifying the target terminal to display the speaking indication information. Herein, the notification message indicating that the target meeting object is speaking may be transmitted to the target terminal corresponding to the first account, namely, a terminal of another meeting place involved in the online meeting. In this case, the target terminal displays the speaking indication information configured for indicating that the target meeting object is speaking. In this way, the speaking indication information is synchronized on the terminal of each meeting place of the online meeting, whereby each user attending the online meeting may learn the meeting object who is currently speaking. Therefore, meeting efficiency and meeting experience are improved.

In some embodiments, the terminal may display, on the meeting interface, the speaking indication information configured for indicating that the target meeting object is speaking in the following manner: displaying a target object identifier of the target meeting object on the meeting interface, and displaying, in an associated area of the target object identifier, the speaking indication information configured for indicating that the target meeting object is speaking.

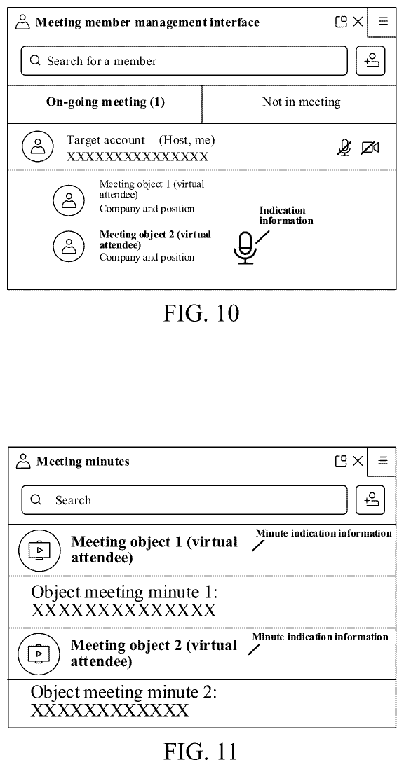

Herein, the terminal may display the target object identifier of the target meeting object on the meeting interface, and display, in the associated area of the target object identifier, the speaking indication information configured for indicating that the target meeting object is speaking. FIG. 10 is a schematic diagram of display of speaking indication information according to some embodiments. Herein, object identifiers of meeting objects (a meeting object 1 and a meeting object 2) are displayed on the meeting interface, and the meeting object 2 is a target meeting object. In this case, in an associated area of the target object identifier of the meeting object 2, speaking indication information configured for indicating that the meeting object 2 is speaking is displayed. The speaking indication information is dynamic image information, namely, a dynamic image of “Microphone”.

In some embodiments, each meeting object has a corresponding object meeting minute, and the terminal may display meeting minutes of the online meeting in the following manner: performing the following processing for each meeting object in response to a meeting minute viewing operation for the online meeting: displaying the object meeting minute of the meeting object, and displaying minute indication information configured for indicating that the object meeting minute belongs to the meeting object.

Herein, when any target meeting object in the plurality of meeting objects speaks, the speaking indication information configured for indicating that the target meeting object is speaking may be displayed. That is, in some embodiments, when any meeting object speaks, the meeting object who is speaking may be clarified. Therefore, when a meeting minute is recorded, the meeting minute may be associated with a corresponding speaking object. In this way, when the meeting minutes of the online meeting are viewed, the object meeting minute of each meeting object may be displayed, and the minute indication information configured for indicating that the object meeting minutes belong to the meeting object is displayed. FIG. 11 is a schematic diagram of display of a meeting minute according to some embodiments. Herein, an object meeting minute 1 and an object meeting minute 2 of a meeting object 1 and a meeting object 2 are displayed, and for each object meeting minute, minute indication information configured for indicating that the object meeting minute belongs to the meeting object is displayed. For example, for the object meeting minute 1, corresponding minute indication information “Meeting object 1” is displayed, and for the object meeting minute 2, corresponding minute indication information “Meeting object 2” is displayed. Herein, the minute indication information is an identifier of the meeting object. In this way, when a meeting minute is viewed, a specific meeting object to which the meeting minute belongs may also be learned, whereby sorting efficiency and viewing efficiency of the meeting minute are improved. Therefore, meeting minute sorting experience after an online meeting is improved.

In some embodiments, the terminal may join a target online meeting in the following manner: displaying a virtual login interface of the target online meeting in response to a meeting joining instruction that is triggered by a target object based on meeting joining information of the target online meeting and that is for the target online meeting; receiving a virtual login account for the target online meeting based on the virtual login interface; binding the virtual login account to a real login account of the target online meeting in response to a confirmation operation for the virtual login account, and displaying a voiceprint registration interface of the target online meeting; receiving an object voice of the target object based on the voiceprint registration interface; and adding a voiceprint of the object voice as an object voiceprint of the target object to an object voiceprint library of the target online meeting in response to a confirmation operation for the object voice, whereby the target object joins the target online meeting based on the virtual login account.

Herein, for the target online meeting different from the foregoing online meeting, the target object (namely, the meeting management object of the foregoing online meeting) may join the target online meeting as a meeting attendance object, that is, the target object joins the target online meeting in a virtual login mode. In some embodiments, the terminal may receive the meeting joining instruction for the target online meeting in one of the following manners: receiving, when the meeting joining information of the target online meeting is a meeting joining graphic code, the meeting joining instruction in response to a scanning operation for the meeting joining graphic code; receiving, when the meeting joining information of the target online meeting is a meeting joining link, the meeting joining instruction in response to an access operation for the meeting joining link; and receiving, when the meeting joining information of the target online meeting is a meeting joining password, the meeting joining instruction in response to a recognition operation for the meeting joining password. Exemplarily, the graphic code may be a quick-response code, a bar code, or the like. The target object may scan the graphic code by using a personal terminal to trigger the joining instruction. The meeting joining link may be transmitted by a terminal of a meeting management object of the target online meeting to the personal terminal of the target object. When receiving the access operation (such as a click operation) for the meeting joining link, the personal terminal of the target object receives the joining instruction. The meeting joining password may be transmitted by the terminal of the meeting management object of the target online meeting to the personal terminal of the target object. When the personal terminal of the target object receives a copying operation for the meeting joining password and in a case that the meeting joining password has been copied, a client supporting an online meeting is activated. The client may automatically perform the recognition operation for the meeting joining password, and receive the joining instruction in response to the recognition operation for the meeting joining password. In this way, the user may join the online meeting in a plurality of manners, and may select an appropriate manner to use as needed, whereby applicable scenarios of the online meeting joining manner are enriched.

The personal terminal of the target object displays the virtual login interface of the target online meeting in response to the meeting joining instruction. The virtual login interface may be provided for the target object to enter the virtual login account. Exemplarily, the virtual login account may be a mobile phone number registered with a client (namely, a client supporting an online meeting), and virtual login is achieved through mobile phone number verification (namely, a mobile phone verification code). When the mobile phone number is not registered with the client, registration may be first performed, and then virtual login is performed. Exemplarily, the virtual login account may be a client account generated by registering with the client, and virtual login is achieved by inputting the client account and a corresponding account password. After logging in with the virtual login account, in response to the confirmation operation for the virtual login account, the virtual login account is bound to the real login account of the target online meeting, and the voiceprint registration interface of the target online meeting is displayed. The voiceprint registration interface is provided for the target object to upload the object voice of the target object, and register the object voiceprint of the target object with the object voiceprint library of the target online meeting. For the voiceprint registration interface, refer to FIG. 5. After the object voice of the target object is received, in response to the confirmation operation for the object voice, the voiceprint of the object voice is added as the object voiceprint of the target object to the object voiceprint library of the target online meeting.

In addition, the trigger operation mentioned in some embodiments may be any operation capable of triggering a corresponding function, such as single click, double click, or drag. The control mentioned in some embodiments may be equivalent to a function item, and may be presented in a plurality of forms, such as a graphical button, a progress bar, a menu, and a list. This is not limited herein.

In some embodiments, when the online meeting is logged in through one target account, and the target account is provided for the plurality of meeting objects in one meeting place to attend the online meeting, the speaking indication information configured for indicating that the target meeting object is speaking may be displayed on the meeting interface when any target meeting object in the plurality of meeting objects speaks. In this way, for a meeting scene in which a plurality of objects in a same meeting place attend an online meeting through one meeting account, different speaking indication information can be displayed when different meeting objects speak, to clearly identify, based on the speaking indication information, which meeting object in the plurality of meeting objects is speaking. Therefore, meeting efficiency and meeting experience of the online meeting are improved.

The following describes exemplary application of the embodiments of this application in an actual application scenario. In the related art, a meeting scene in which a plurality of objects in a same meeting room attend an online meeting is achieved in the following manner: all attendees log in to the online meeting through only one meeting account/device and speak through a microphone associated with the meeting account/device. However, the following problem will occur during the online meeting: because an online meeting system can recognize only one meeting account (a meeting account of a current login object or a meeting account of a meeting hardware device), speeches of all attendees in the meeting room are identified as speeches of the meeting account, and recognized meeting minutes are also considered as meeting minutes of the meeting account, and the speeches and the meeting minutes cannot be associated with real attendees. In addition, another attendee who is not in the same meeting room and who is in the online meeting cannot determine who a current speaker is, which greatly affects efficiency and atmosphere of the online meeting.

Based on this, some embodiments provide an online meeting processing method, to solve at least the foregoing existing problems. In some embodiments, for a meeting scene in which a plurality of objects in a same meeting place attend an online meeting and log in to the online meeting through only one meeting account/device, 1) an online meeting system (that is, an online meeting backend) is enabled to automatically recognize a current speaker through virtual login of all attendees to the online meeting and a speaker recognition technology. 2) A direction of a voice is recognized by using a microphone of the online meeting system, whereby the online meeting system can recognize a current speaker according to the direction of the voice. 3) One physical button is allocated to each attendee, and the attendee may press the physical button when speaking, whereby the online meeting system can recognize a current speaker through the physical button. In this way, different speakers in the online meeting may be identified, whereby each current speaker can be identified and a meeting minute can be associated with a real speaker.

Next, the solution 1) in which the online meeting system is enabled to automatically recognize the current speaker through virtual login of all attendees to the online meeting and the speaker identification technology is described in detail.

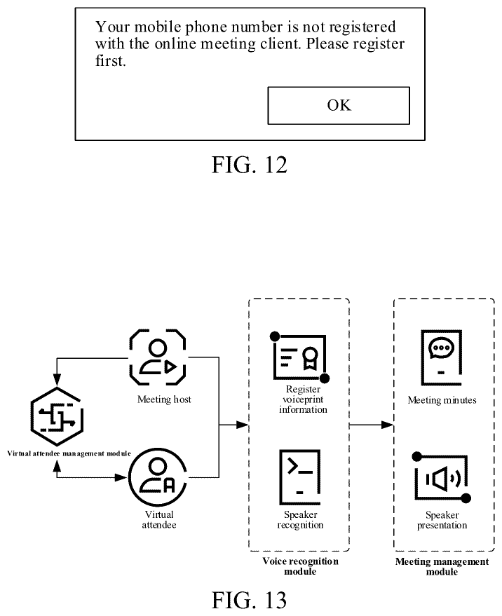

First, the online meeting processing method provided in some embodiments is described from the perspective of a product.
(1) A meeting management object (such as a meeting host or co-host) may select, on a meeting scheduling interface, whether to enable virtual login, as shown in FIG. 4.
(2) After the meeting management object selects to enable virtual login, when logging in to an online meeting, the meeting management object may register a voiceprint of the meeting management object by reading a few short sentences or uploading a piece of voice of the meeting management object to the online meeting system, as shown in FIG. 5.
(3) As shown in FIG. 6, the meeting management object may add a virtual attendee (corresponding to a meeting attendance object) to a member management interface, and after the meeting management object clicks to add the virtual attendee, the online meeting system automatically generates a quick-response code and presents the quick-response code under a name identifier of the meeting management object. Because the virtual attendee needs to be registered under the meeting management object name, each meeting room needs to have at least one meeting management object.
(4) When virtually logs in to the scheduled online meeting, the virtual attendee may scan, by using a personal terminal (such as a mobile phone), the quick-response code displayed under the name identifier of the meeting management object. In this case, the personal terminal of the virtual attendee displays content shown in FIG. 7(2). The virtual attendee may enter a mobile phone number of the virtual attendee to acquire a verification code, and complete virtual login of the virtual attendee after entering the verification code, without the need of entering a client login password of an online meeting client.
(5) If the inputted mobile phone number has not registered with the online meeting client, the online meeting system prompts a user to register with the online meeting client; otherwise, virtual login cannot be completed. FIG. 12 is a schematic diagram of registration with an online meeting client according to some embodiments.
(6) When performing virtual login, the virtual attendee also needs to read a few short sentences on the personal terminal (namely, the mobile phone) or upload a piece of voice of the virtual attendee to the online meeting system, to register the voiceprint of the corresponding virtual attendee, as shown in FIG. 7(3).
(7) As shown in FIG. 8(1), after virtual login is completed, the online meeting system automatically recognizes information, such as a name, a company, and a position, about the virtual attendee based on the mobile phone number, and presents acquired information on a member management interface. The virtual attendee may perform an operation of exiting the meeting, but cannot perform operations of enabling a microphone/camera, enabling a shared screen, and the like. The operations of enabling a microphone/camera, enabling a shared screen, and the like may be performed by the meeting management object.
(8) During the online meeting, the online meeting system recognizes a current speaker in the online meeting based on the registered voiceprint, and identifies the current speaker on the meeting interface, whereby another attendee learns an attendee who is speaking, as shown in FIG. 9 and FIG. 10. In addition, meeting minutes are recorded and associated with real speakers, as shown in FIG. 11.
(9) Because the online meeting is provided for attendees in a plurality of different meeting places to attend the online meeting, the online meeting may include a meeting management object corresponding to each meeting place, and attendees in different meeting places virtually log in to the online meeting through the meeting management objects in corresponding meeting places. Therefore, the meeting management object may remove a virtual attendee registered under the meeting management object from the online meeting, but cannot remove a virtual attendee registered under another meeting management object from the online meeting, as shown in FIG. 8.
(10) When the meeting management object exits the online meeting, the virtual attendee registered under the meeting management object also automatically exits the online meeting.

Then, the online meeting processing method provided in some embodiments is described in detail from the perspective of the technology.

FIG. 13 is a schematic flowchart of an online meeting processing method according to some embodiments. A voice recognition module is mainly responsible for storing (registering) voiceprint information of an attendee (that is, a meeting object), and recognizing a current speaker based on the stored voiceprint information. A meeting management module is mainly responsible for presenting meeting minutes and a user interface of an online meeting system after the current speaker is recognized. A virtual attendee management module is mainly responsible for login of a virtual attendee, management of a meeting management object (namely, a meeting host) for the virtual attendee, and the like. A detailed description is provided below.

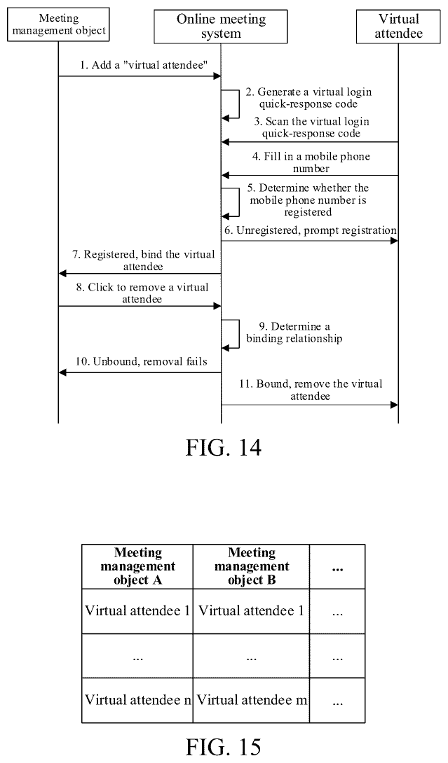

(1) Virtual attendee management module: the virtual attendee management module mainly implements login of the virtual attendee, and binds the virtual attendee to the meeting management object. FIG. 14 is a schematic flowchart of processing of a virtual attendee management module according to some embodiments.

1. A meeting management object clicks “Add a virtual attendee”. 2. An online meeting system automatically generates a quick-response code used for virtual login. 3. A virtual attendee scans the quick-response code. 4. The virtual attendee fills in a mobile phone number. 5. The online meeting system determines whether the mobile phone number of the virtual attendee has been registered with an online meeting client, and performs 7 if the mobile phone number has been registered with the online meeting client, or performs 6 if the mobile phone number has not been registered with the online meeting client yet. 6. The online meeting system prompts the virtual attendee to perform registration. 7. The online meeting system automatically acquires information, such as a name and a position, about the virtual attendee (to be used in scenarios such as presentation of a meeting system interface and meeting minutes), and binds the virtual attendee to the meeting management object. In this way, after virtual login, the virtual attendee forms a binding relationship (many-to-one) with a generator of the quick-response code (namely, the meeting management object). The binding relationship may be shown in FIG. 15 (FIG. 15 is a schematic diagram of a binding relationship between a meeting management object and a virtual attendee according to some embodiments), and the meeting management object can only perform an operation on the virtual attendee bound to the meeting management object. 8. The meeting management object clicks to remove a virtual attendee. 9. The online meeting system determines whether the virtual attendee and the meeting management object are in a binding relationship, and performs 11 if the virtual attendee and the meeting management object are in the binding relationship, or performs 10 if the virtual attendee and the meeting management object are not in the binding relationship. 10. The online meeting systems fails to remove the virtual attendee because the virtual attendee is not bound to the meeting management object. 11. The online meeting system removes the virtual attendee because the virtual attendee is bound to the meeting management object.

In addition, the attendee is referred to as a virtual attendee because the attendee does not independently log in to the online meeting system through an online meeting account and a password in the real sense, but performs virtual login after binding the meeting management object by scanning the quick-response code, does not enter a login password during virtual login, can only exit the online meeting, and cannot perform operations of muting/unmuting a microphone, sharing a screen, turning on/off a camera, and the like. Only one object (namely, the meeting management object) actually always logs in to the online meeting system.

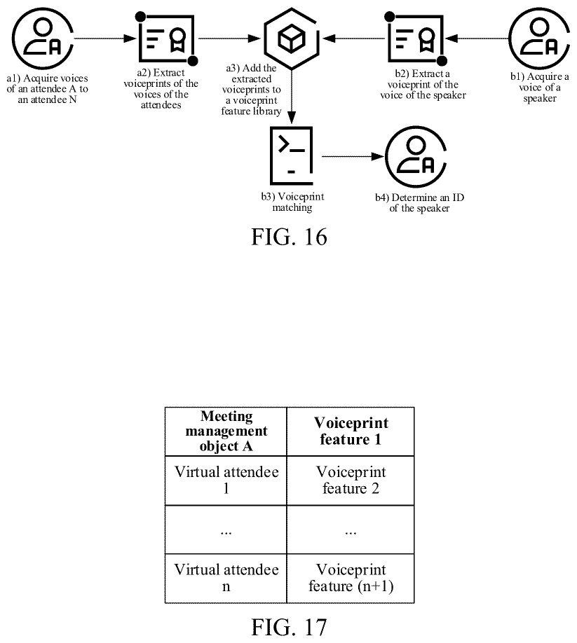

(2) Voice recognition module: the voice recognition module mainly exerts two functions: voiceprint registration and speaker identification. FIG. 16 is a schematic flowchart of processing of a voice recognition module according to some embodiments. During voiceprint registration, the voice recognition module a1) acquires voices of an attendee A to an attendee N; a2) separately extracts voiceprint features from the voices of the attendee A to the attendee N; and a3) adds the extracted voiceprint features to a voiceprint feature library. During speaker identification, the voice recognition module b1) acquires a voice of a current speaker; b2) extracts a voiceprint feature from the voice of the current speaker; b3) matches the voiceprint feature of the voice of the speaker with voiceprint features in the voiceprint feature library, to obtain a matching result; and b4) determines an identity document (ID) of the speaker according to the matching result.

A voiceprint feature is one type of biometric recognition features, is extracted when a speaker is speaking, may be taken as a representation and an identifier of the speaker, and is a generic term for voice features that can distinguish the speaker from other objects, and voice models established based on these features or parameters. Voiceprint recognition feature parameters may include linear predictive coding (LPC) features and Mel-frequency cepstral coefficient (MFCC) features. FIG. 17 is a schematic diagram of storage of a voiceprint feature according to some embodiments. After extracting the voiceprint features of the attendees, the online meeting system stores the voiceprint features in a format shown in FIG. 17. When an attendee in a same meeting room speaks, the online meeting system extracts a voiceprint feature of the speaker, and performs cross retrieval in the foregoing voiceprint feature library, to check whether the voiceprint feature is matched with a voiceprint feature in the voiceprint feature library. If the matching succeeds, it indicates that the current speaker has been recognized. After the speaker is recognized, related information (such as a name and a position) of the speaker may be used in the meeting management module to identify the speaker.

(3) Meeting management module: after the virtual attendee who is currently speaking is recognized, the meeting management module mainly identifies the virtual attendee who is currently speaking on another interface having an attendee identifier, such as a meeting system interface or a meeting minute interface. For example, a) a meeting attendance member interface includes a meeting attendance member main interface and a meeting attendance member list interface, and presents information, such as a name and a position, about a virtual attendee; b) a current speaker interface includes the meeting attendance member main interface and the meeting attendance member list interface, and displays an identifier (a microphone in a target color (such as green)) indicating that the virtual attendee is speaking; and c) a meeting minutes interface displays a name of a virtual attendee and meeting minute content. In some embodiments, a similar method may be applied to all subsequent newly added interfaces that need to identify a current speaker, to identify a virtual attendee who is currently speaking.

By applying the foregoing embodiments of this application, in a meeting scene in which a plurality of objects in a same meeting place attend an online meeting and log in to the online meeting through only one meeting account/device, when any target attendee in the online meeting speaks, an identifier configured for indicating that the target attendee is speaking is displayed, to identify different current speakers in the online meeting. In addition, an online meeting system is enabled to automatically identify a current speaker through a speaker recognition technology, whereby meeting minutes can be associated with real speakers.

The following describes an exemplary structure of the online meeting processing apparatus 555 provided in some embodiments that is implemented as a software module. In some embodiments, as shown in FIG. 2, software modules in the online meeting processing apparatus 555 stored in the memory 550 may include: a first display module 5551, configured to display a meeting interface of an online meeting logged in through one target account, the target account being provided for a plurality of meeting objects in one meeting place to attend the online meeting; and a second display module 5552, configured to display, on the meeting interface when any target meeting object in the plurality of meeting objects speaks, speaking indication information configured for indicating that the target meeting object is speaking.

In some embodiments, before displaying the meeting interface of the online meeting logged in through one target account, the first display module 5551 is further configured to display a meeting scheduling interface; receive meeting setting information for the online meeting based on the meeting scheduling interface; and schedule the online meeting in response to a confirmation operation for the meeting setting information.

In some embodiments, the online meeting has an object voiceprint library, and the object voiceprint library includes an object voiceprint of each meeting object in the plurality of meeting objects; and before displaying, on the meeting interface when any target meeting object in the plurality of meeting objects speaks, the speaking indication information configured for indicating that the target meeting object is speaking, the second display module 5552 is further configured to perform voice detection on the online meeting, and acquire a voiceprint of a target voice when the target voice is detected; match the voiceprint with each object voiceprint, to obtain a matching result; and determine, when the matching result represents that a target object voiceprint matched with the voiceprint exists, that a meeting object having the target object voiceprint is speaking, the meeting object having the target object voiceprint being the target meeting object.

In some embodiments, the target account belongs to a meeting management object in the plurality of meeting objects, and before displaying the meeting interface of the online meeting logged in through one target account, the first display module 5551 is further configured to display a voiceprint registration interface of the online meeting in response to a first entry instruction of the meeting management object for the online meeting; receive an object voice of the meeting management object based on the voiceprint registration interface; and add a voiceprint of the object voice as an object voiceprint of the meeting management object to the object voiceprint library in response to a confirmation operation for the object voice.

In some embodiments, the first display module 5551 is further configured to display a voice collection control and voice collection reference text on the voiceprint registration interface; and receive, based on the voice collection control, an object voice of the meeting management object reading the voice collection reference text.

In some embodiments, the first display module 5551 is further configured to display a voice file uploading control on the voiceprint registration interface; receive an uploaded voice file of the meeting management object based on the voice file uploading control; and take a voice included in the voice file as the object voice in response to a confirmation operation for the voice file.

In some embodiments, the target account belongs to the meeting management object in the plurality of meeting objects, and the first display module 5551 is further configured to display a meeting object addition control of the online meeting; and display meeting joining information in response to a trigger operation of the meeting management object for the meeting object addition control, the meeting joining information being configured for joining the online meeting in a virtual login mode in response to a joining instruction that is triggered by a meeting attendance object based on the meeting joining information and that is for the online meeting, and the meeting attendance object being a meeting object other than the meeting management object in the plurality of meeting objects; and the virtual login mode being configured for instructing to bind a virtual login account to the target account when the virtual login account of the meeting attendance object is received, and registering an object voiceprint of the meeting attendance object with the object voiceprint library, and the meeting attendance object joining the online meeting based on the virtual login account.

In some embodiments, the first display module 5551 is further configured to display a virtual login switch of the online meeting; control the online meeting to be in the virtual login mode in response to an enabling instruction for the virtual login switch; and display the meeting object addition control of the online meeting when the online meeting is in the virtual login mode.

In some embodiments, the meeting attendance object joins the online meeting in the virtual login mode, and the first display module 5551 is further configured to display an account removal control of the virtual login account; and control, in response to a trigger operation for the account removal control, the virtual login account to exit the online meeting.

In some embodiments, the meeting attendance object joins the online meeting in the virtual login mode, and the first display module 5551 is further configured to control, in response to a meeting exit operation for the target account, the target account to exit the online meeting, and control the virtual login account bound to the target account to exit the online meeting.

In some embodiments, before displaying the meeting interface of the online meeting logged in through one target account, the first display module 5551 is further configured to display a voiceprint addition control; display the voiceprint registration interface of the online meeting in response to a trigger operation for the voiceprint addition control; receive an object voice of a meeting object and an object identifier of the meeting object based on the voiceprint registration interface; and take a voiceprint of the object voice as an object voiceprint of the meeting object in response to a confirmation operation for the object voice, and associatively add the object voiceprint and the object identifier to the object voiceprint library.

In some embodiments, each meeting object in the plurality of meeting objects corresponds to one speaking control key; and before displaying, on the meeting interface when any target meeting object in the plurality of meeting objects speaks, the speaking indication information configured for indicating that the target meeting object is speaking, the second display module 5552 is further configured to detect whether the speaking control key corresponding to each meeting object is in a pressed state, to obtain a detection result; and determine, when the detection result represents that a target speaking control key is in the pressed state, that a meeting object corresponding to the target speaking control key is speaking, the meeting object corresponding to the target speaking control key being the target meeting object.

In some embodiments, before displaying, on the meeting interface when any target meeting object in the plurality of meeting objects speaks, the speaking indication information configured for indicating that the target meeting object is speaking, the second display module 5552 is further configured to perform voice detection on the online meeting, and recognize a target speaking direction of the target voice when the target voice is detected; acquire an object speaking direction of each meeting object in the plurality of meeting objects, and match the target speaking direction with each object speaking direction, to obtain a matching result; and determine, when the matching result represents that a target object speaking direction matched with the target speaking direction exists, that a meeting object corresponding to the target object speaking direction is speaking, the meeting object corresponding to the target object speaking direction being the target meeting object.

In some embodiments, the second display module 5552 is further configured to display a target object identifier of the target meeting object on the meeting interface, and display, in an associated area of the target object identifier, the speaking indication information configured for indicating that the target meeting object is speaking.

In some embodiments, each meeting object has a corresponding object meeting minute, and the second display module 5552 is further configured to perform the following processing for each meeting object in response to a meeting minute viewing operation for the online meeting: displaying the object meeting minute of the meeting object, and displaying minute indication information configured for indicating that the object meeting minute belongs to the meeting object.

In some embodiments, the second display module 5552 is further configured to transmit, to a target terminal logged in through a first account, a notification message indicating that the target meeting object is speaking, the first account being provided for a meeting object in a target meeting place different from the meeting place to attend the online meeting; and the notification message being configured for notifying the target terminal to display the speaking indication information.

In some embodiments, the first display module 5551 is further configured to display a virtual login interface of a target online meeting in response to a meeting joining instruction that is triggered by a target object based on meeting joining information of the target online meeting and that is for the target online meeting; receive a virtual login account for the target online meeting based on the virtual login interface; bind the virtual login account to a real login account of the target online meeting in response to a confirmation operation for the virtual login account, and display a voiceprint registration interface of the target online meeting; receive an object voice of the target object based on the voiceprint registration interface; and add a voiceprint of the object voice as an object voiceprint of the target object to an object voiceprint library of the target online meeting in response to a confirmation operation for the object voice, whereby the target object joins the target online meeting based on the virtual login account.

In some embodiments, the first display module 5551 is further configured to receive the meeting joining instruction in one of the following manners: receiving, when the meeting joining information is a meeting joining graphic code, the meeting joining instruction in response to a scanning operation for the meeting joining graphic code; receiving, when the meeting joining information is a meeting joining link, the meeting joining instruction in response to an access operation for the meeting joining link; and receiving, when the meeting joining information is a meeting joining password, the meeting joining instruction in response to a recognition operation for the meeting joining password.

According to some embodiments, when the online meeting is logged in through one target account, and the target account is provided for the plurality of meeting objects in one meeting place to attend the online meeting, the speaking indication information configured for indicating that the target meeting object is speaking may be displayed on the meeting interface when any target meeting object in the plurality of meeting objects speaks. In this way, for a meeting scene in which a plurality of objects in a same meeting place attend an online meeting through one meeting account, different speaking indication information can be displayed when different meeting objects speak, to clearly identify, based on the speaking indication information, which meeting object in the plurality of meeting objects is speaking. Therefore, meeting efficiency and meeting experience of the online meeting are improved.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

According to some embodiments, each module in the apparatus may exist respectively or be combined into one or more units. Certain (or some) unit in the units may be further split into multiple smaller function subunits, thereby implementing the same operations without affecting the technical effects of some embodiments. The modules are divided based on logical functions. In actual applications, a function of one module may be realized by multiple units, or functions of multiple modules may be realized by one unit. In some embodiments, the apparatus may further include other units. In actual applications, these functions may also be realized cooperatively by the other units, and may be realized cooperatively by multiple units.

Some embodiments further provide a computer program product, which includes computer-executable instructions or a computer program. The computer-executable instructions or the computer program is stored in a computer-readable storage medium. A processor of an electronic device reads the computer-executable instructions or the computer program from the computer-readable storage medium, and executes the computer-executable instructions or the computer program, to cause the electronic device to perform the online meeting processing method provided in some embodiments.

Some embodiments further provide a computer-readable storage medium, which has computer-executable instructions or a computer program stored therein. A processor executes the computer-executable instructions or the computer program, to perform the online meeting processing method provided in some embodiments.

In some embodiments, the computer-readable storage medium may be a memory such as a random-access memory (RAM), a read-only memory (ROM), a flash memory, a magnetic surface memory, a compact disc, or a compact disc ROM (CD-ROM); or may be any device including one or any combination of the foregoing memories.

In some embodiments, the computer-executable instructions may be written in the form of program, software, software module, script, or code in any form of programming language (including compilation or interpretation language, or declarative or procedural language), and may be deployed in any form, including being deployed as an independent program or being deployed as a module, component, subroutine, or another unit suitable for use in a computing environment.

As an example, the computer-executable instructions may but does not necessarily correspond to a file in a file system, may be stored in a part of a file for storing other programs or data, for example, stored in one or more scripts in a Hypertext Markup Language (HTML) document, stored in a single file dedicated to the program in question, or stored in a plurality of collaborative files (such as files storing one or more modules, subprograms, or code parts).

As an example, the computer-executable instructions may be deployed to be executed on one electronic device, on a plurality of electronic devices located at one site, or on a plurality of electronic devices distributed at a plurality of locations and connected by a communication network.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. An online meeting processing method, performed by an electronic device, comprising:
displaying a meeting interface of an online meeting logged in through a target account, the target account being provided for a plurality of meeting objects in a meeting place to attend the online meeting; and
displaying, on the meeting interface, speaking indication information indicating that a target meeting object is speaking when a target meeting object in the plurality of meeting objects speaks.

2. The online meeting processing method according to claim 1, before displaying the meeting interface of the online meeting logged in through the target account, further comprising:
displaying a meeting scheduling interface;
receiving meeting setting information for the online meeting based on the meeting scheduling interface; and
scheduling the online meeting in response to a confirmation operation for the meeting setting information.

3. The online meeting processing method according to claim 1, wherein the online meeting has an object voiceprint library, and the object voiceprint library comprises an object voiceprint of each meeting object in the plurality of meeting objects; and
before displaying, on the meeting interface, the speaking indication information indicating that the target meeting object is speaking, the method further comprises:
performing voice detection on the online meeting, and acquiring a voiceprint of a target voice;
comparing the voiceprint with each object voiceprint to obtain a matching result; and
determining, based on the matching result indicating that a target object voiceprint matching with the voiceprint exists, that a meeting object having the target object voiceprint is speaking, the meeting object having the target object voiceprint being the target meeting object.

4. The online meeting processing method according to claim 3, wherein the target account belongs to a meeting management object in the plurality of meeting objects, and before displaying the meeting interface of the online meeting logged in through the target account, the method further comprises:
displaying a voiceprint registration interface of the online meeting based on a first entry instruction of the meeting management object for the online meeting;
receiving an object voice of the meeting management object based on the voiceprint registration interface; and
adding the voiceprint of the object voice as an object voiceprint of the meeting management object to the object voiceprint library based on a first confirmation operation for the object voice.

5. The online meeting processing method according to claim 4, further comprising:
displaying a voice collection control and voice collection reference text on the voiceprint registration interface,
wherein receiving the object voice of the meeting management object based on the voiceprint registration interface comprises:
receiving, based on the voice collection control, the object voice of the meeting management object reading the voice collection reference text.

6. The online meeting processing method according to claim 4, further comprising:
displaying a voice file uploading control on the voiceprint registration interface,
wherein receiving the object voice of the meeting management object based on the voiceprint registration interface comprises:
receiving an uploaded voice file of the meeting management object based on the voice file uploading control; and
taking a voice comprised in the uploaded voice file as the object voice based on a second confirmation operation for the uploaded voice file.

7. The online meeting processing method according to claim 3, wherein the target account belongs to a meeting management object in the plurality of meeting objects, and the method further comprises:
displaying a meeting object addition control of the online meeting; and
displaying meeting joining information based on a trigger operation of the meeting management object for the meeting object addition control,
the meeting joining information being configured for joining the online meeting in a virtual login mode based on a joining instruction that is triggered by a meeting attendance object according to the meeting joining information and that is for the online meeting, and the meeting attendance object being a meeting object other than the meeting management object in the plurality of meeting objects; and
the virtual login mode being configured for instructing to bind a virtual login account to the target account when the virtual login account of the meeting attendance object is received, and registering the object voiceprint of the meeting attendance object with the object voiceprint library, and the meeting attendance object joining the online meeting based on the virtual login account.

8. The online meeting processing method according to claim 7, further comprising:
displaying a virtual login switch of the online meeting; and
controlling the online meeting to be in the virtual login mode based on an enabling instruction for the virtual login switch,
wherein displaying the meeting object addition control of the online meeting comprises:
displaying the meeting object addition control of the online meeting when the online meeting is in the virtual login mode.

9. The online meeting processing method according to claim 7, wherein the meeting attendance object joins the online meeting in the virtual login mode, and the method further comprises:
displaying an account removal control of the virtual login account; and
controlling, based on a trigger operation for the account removal control, the virtual login account to exit the online meeting.

10. The online meeting processing method according to claim 7, wherein the meeting attendance object joins the online meeting in the virtual login mode, and the method further comprises:
controlling, based on a meeting exit operation for the target account, the target account to exit the online meeting, and controlling the virtual login account bound to the target account to exit the online meeting.

11. The online meeting processing method according to claim 3, wherein before displaying the meeting interface of the online meeting logged in through the target account, the method further comprises:
displaying a voiceprint addition control;
displaying a voiceprint registration interface of the online meeting based on a trigger operation for the voiceprint addition control;
receiving an object voice of a meeting object and an object identifier of the meeting object based on the voiceprint registration interface; and
taking the voiceprint of the object voice as an object voiceprint of the meeting object based on a confirmation operation for the object voice, and associatively adding the object voiceprint and the object identifier to the object voiceprint library.

12. The online meeting processing method according to claim 1, wherein each meeting object in the plurality of meeting objects corresponds to a speaking control key; and
before displaying, on the meeting interface, the speaking indication information indicating that the target meeting object is speaking, the method further comprises:
detecting whether the speaking control key corresponding to each meeting object is in a pressed state to obtain a detection result; and
determining, based on the detection result indicating that a target speaking control key is in the pressed state, that a meeting object corresponding to the target speaking control key is speaking, the meeting object corresponding to the target speaking control key being the target meeting object.

13. The online meeting processing method according to claim 1, wherein before displaying, on the meeting interface, the speaking indication information indicating that the target meeting object is speaking, the method further comprises:
performing voice detection on the online meeting, and recognizing a target speaking direction of a target voice when the target voice is detected;
acquiring an object speaking direction of each meeting object in the plurality of meeting objects, and comparing the target speaking direction with each object speaking direction to obtain a matching result; and
determining, based on the matching result indicating that a target object speaking direction matching with the target speaking direction exists, that a meeting object corresponding to the target object speaking direction is speaking, the meeting object corresponding to the target object speaking direction being the target meeting object.

14. The online meeting processing method according to claim 1, wherein displaying, on the meeting interface, the speaking indication information indicating that the target meeting object is speaking comprises:
displaying a target object identifier of the target meeting object on the meeting interface; and
displaying, in an associated area of the target object identifier, the speaking indication information indicating that the target meeting object is speaking.

15. The online meeting processing method according to claim 1, wherein each meeting object has a corresponding object meeting minute, and the method further comprises, for each meeting object based on a meeting minute viewing operation for the online meeting:
displaying the corresponding object meeting minute of the meeting object, and displaying minute indication information indicating that the corresponding object meeting minute belongs to the meeting object.

16. The online meeting processing method according to claim 1, further comprising:
transmitting, to a target terminal logged in through a first account, a notification message indicating that the target meeting object is speaking to notify the target terminal to display the speaking indication information,
the first account being provided for a meeting object in a target meeting place different from the meeting place to attend the online meeting.

17. The online meeting processing method according to claim 1, further comprising:
displaying a virtual login interface of a target online meeting based on a meeting joining instruction that is triggered by a target object according to meeting joining information of the target online meeting and that is for the target online meeting;
receiving a virtual login account for the target online meeting based on the virtual login interface;
binding the virtual login account to a real login account of the target online meeting based on a first confirmation operation for the virtual login account, and displaying a voiceprint registration interface of the target online meeting;
receiving an object voice of the target object based on the voiceprint registration interface; and
adding a voiceprint of the object voice as an object voiceprint of the target object to an object voiceprint library of the target online meeting based on a second confirmation operation for the object voice, the target object joining the target online meeting through the virtual login account.

18. The online meeting processing method according to claim 17, further comprising:
receiving the meeting joining instruction in at least one of the following manners:
receiving, when the meeting joining information is a meeting joining graphic code, the meeting joining instruction based on a scanning operation for the meeting joining graphic code;
receiving, when the meeting joining information is a meeting joining link, the meeting joining instruction based on an access operation for the meeting joining link; and
receiving, when the meeting joining information is a meeting joining password, the meeting joining instruction based on a recognition operation for the meeting joining password.

19. An online meeting processing apparatus, comprising:
at least one memory configured to store computer program code;
at least one processor configured to read the program code and operate as instructed by the program code, the program code comprising:
first display code configured to cause at least one of the at least one processor to display a meeting interface of an online meeting logged in through one target account, the target account being provided for a plurality of meeting objects in one meeting place to attend the online meeting; and
second display code configured to cause at least one of the at least one processor to display, on the meeting interface, speaking indication information indicating that a target meeting object is speaking when an target meeting object in the plurality of meeting objects speaks.

20. A non-transitory computer-readable storage medium, storing computer code which, when executed by at least one processor, causes the at least one processor to at least:
display a meeting interface of an online meeting logged in through a target account, the target account being provided for a plurality of meeting objects in a meeting place to attend the online meeting; and
display, on the meeting interface, speaking indication information indicating that a target meeting object is speaking when an target meeting object in the plurality of meeting objects speaks.
